(19) United States
(12) Patent Application Publication
(10) Pub. No.: US 2017/0370783 A1
(43) Pub. Date: Dec. 28, 2017

(54) Nanoscale Temperature Sensor

(71) Applicant: THE REGENTS OF THE UNIVERSITY OF MICHIGAN, Ann Arbor, MI (US)

(72) Inventors: Somin Eunice LEE, Ann Arbor, MI (US); Yunbo LIU, Ann Arbor, MI (US)

(21) Appl. No.: 15/632,307

(22) Filed: Jun. 24, 2017

Related U.S. Application Data
(60) Provisional application No. 62/354,290, filed on Jun. 24, 2016.

(51) Int. Cl. G01K 11/12; G01K 5/70

(52) U.S. Cl. CPC G01K 11/125; G01K 5/70; Y10S 977/955

(57) ABSTRACT

A nanoscale temperature sensor is presented that is based on mechano-optical sensing. The temperature sensor features a nanoscale bilayer sensing member with a footprint of <100 nm. The sensing member is composed of two layers of materials with similar elastic modulus but different coefficients of thermal expansion. This difference in coefficients of thermal expansion causes the sensing member to mechanically deform upon temperature change. The deformation of the sensing member alters its optical properties, allowing the temperature measurement to be achieved by far field imaging with high throughput. Both the mechanical and optical properties of the sensing member are reversible thus allow stable and repeatable measurement.

### CROSS-REFERENCE TO RELATED APPLICATIONS

This application claims the benefit of U.S. Provisional Application No. 62/354,290, filed on Jun. 24, 2016. The entire disclosure of the above application is incorporated herein by reference.

### GOVERNMENT CLAUSE

This invention was made with government support under Grant No. FA9550-16-1-0272 awarded by the U.S. Air Force/Air Force Office of Scientific Research and Grant No. 1454188 awarded by the National Science Foundation. The Government has certain rights in this invention.

### FIELD

The present disclosure relates to a nanoscale temperature sensor.

### BACKGROUND

The ability to detect the repeated occurrence, precise spatial location, and severity of temperature in real-time is needed in many areas of medicine, structural health monitoring, material interfaces, and electronic heat management. In particular, nanoscale-sensing approaches can offer unparalleled spatial temperature information that is not available through conventional methods. While many promising nanoscale approaches are being explored, currently available chromophore, quantum dot, and nanodiamond-based temperature sensors suffer from small dynamic range, stochastic blinking phenomena (i.e., fluctuating intensities), and/or photobleaching, limiting the ability to continuously and quantitatively measure absolute temperatures. In order to advance dynamic studies of temperature, new temperature sensors that are simultaneously capable of nanometer spatial resolution and stability over a broad temperature range are needed.

This section provides background information related to the present disclosure which is not necessarily prior art.

### SUMMARY

This section provides a general summary of the disclosure, and is not a comprehensive disclosure of its full scope or all of its features.

A nanoscale temperature sensor is presented. The temperature sensor includes a temperature sensing member having a planar shape. The temperature sensing member is comprised of a layer of a first material disposed on a layer of a second material. The first material has an elastic modulus similar to the second material but a coefficient of thermal expansion different than the second material. For example, the difference between the elastic modulus of the first material and the elastic modulus of the second material is less than two hundred percent; whereas, the difference between the coefficient of thermal expansion of the first material and the coefficient of thermal expansion of the second material is greater than five thousand percent.

In one embodiment, the first material is a metal with strong localized surface plasmon resonance, such as gold, and the second material is a polymer.

In some embodiments, the dimensions of the temperature sensing member are on the order of nanometers.

In one aspect, a non-contact system is presented for measuring temperature of an object. The system includes one or more temperature sensing membranes disposed on a surface of the object. The temperature sensing members are comprised of a layer of a first material disposed on a layer of a second material, such that the first material has an elastic modulus similar to the second material but a coefficient of thermal expansion different than the second material. A light source operates to project light onto the temperature sensing member and a light detector is configured to receive light reflect by the temperature sensing member. A controller is interfaced with the light detector and operates to determine a temperature based on a change in optical properties of light reflect by the temperature sensing member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B are diagrams depicting an example temperature sensing member for a nanoscale temperature sensor in an ambient temperature and an elevated temperature, respectively;

FIG. 1C is a graph illustrating how localized surface plasmon resonance of the temperature sensing member shifts as a result of temperature induced mechanical displacement;

FIG. 1D is a diagram showing volume displacement of the temperature sensing member;

FIG. 2 is a diagram illustrating geometric parameters defining the temperature sensing member;

FIG. 3 is a graph illustrating the absorption spectra of the temperature sensing member as a function of the radius of curvature;

FIG. 4 is a radar chart showing the wavelength shift caused by the temperature sensing member at various temperatures while tuning the thickness ratio and length of the temperature sensing member;

FIG. 5 is a two-dimensional interpolation map of the wavelength shift and Young's moduli for the temperature sensing member at an elevated temperature 300 degrees Celsius above room temperature;

FIG. 6 is a diagram depicting an array of temperature sensing members disposed on a sensing skin;

FIG. 7 is a diagram of a non-contact system for measuring temperature using the temperature sensing members;

FIG. 8 is a diagram of a particular embodiment of the non-contact system for measuring temperature; and

FIG. 9 is a graph illustrating the correlation between a wavelength shift and temperature change.

Corresponding reference numerals indicate corresponding parts throughout the several views of the drawings.

### DETAILED DESCRIPTION

Example embodiments will now be described more fully with reference to the accompanying drawings.

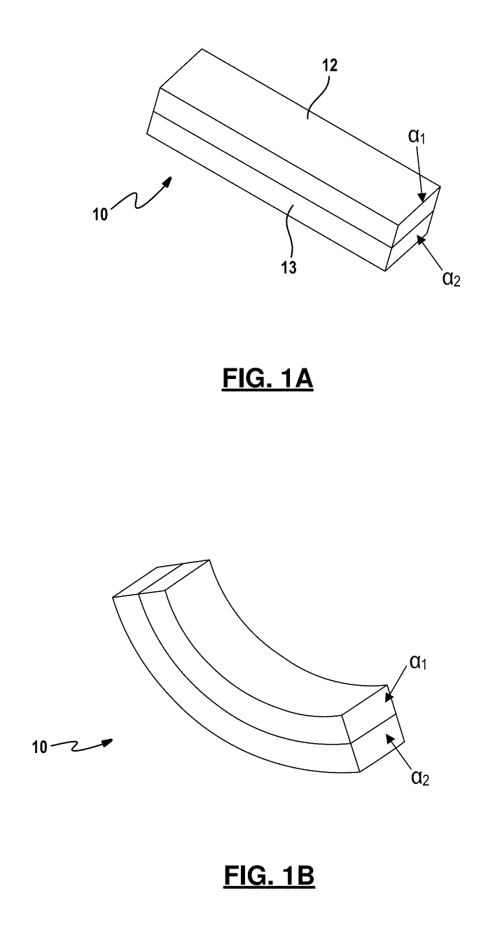

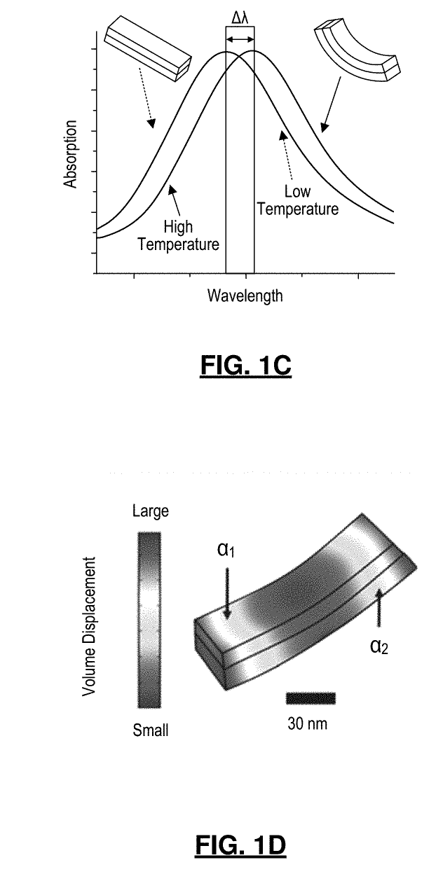

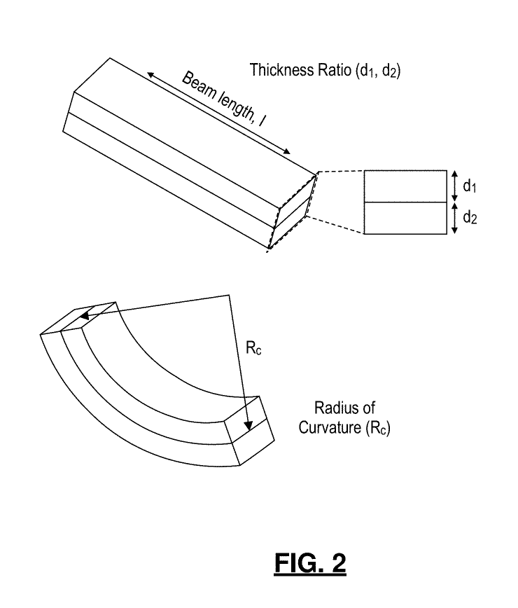

FIGS. 1A and 1B depict a temperature sensing member 10 for a nanoscale temperature sensor. The temperature sensing member 10 has a two layer construction with a planar shape. In an example embodiment, the temperature sensing member 10 is a beam or in shape of a rectangular cuboid. The dimensions of the temperature sensing member 10 are on the order of nanometers. For example, the temperature sensor member 10 in the shape of a rectangular cuboid has a length less than one hundred nanometers. Other shapes with a flat profile are contemplated for the temperature sensing member 10 including an elliptic cylinder and a rhombohedron.

The two layers of the temperature sensing member 10 are formed from different materials. A first layer 12 is comprised of a first material and a second layer 13 is comprised of a second material. Of note, the first material has an elastic modulus similar to the second material but a coefficient of thermal expansion that is different from the second material. For example, the elastic modulus may be in the range of 2-200 Gpa with the similarity being quantified as a difference between the elastic modulus of the first material and the elastic modulus of the second material less than 200%. On the other hand, the coefficient of thermal expansion may be in the range of 4.5*10⁻⁶ to 100*10⁻⁶ K⁻¹ with the difference being quantified as a difference between the coefficient of thermal expansion of the first material and the coefficient of thermal expansion of the second material is greater than 5000%. This difference in coefficient of thermal expansion causes the temperature sensing member 10 to mechanically deform in response to temperature changes. Specifically, the temperature sensing member 10 bends along its longitudinal axis as seen in FIG. 1B. As further described below, the deformation of the sensing member 10 alters its optical properties, thereby allowing the temperature measurement to be achieved by far field imaging with high throughput. Both the mechanical and optical properties of the sensing member 10 are reversible to enable stable and repeatable temperature measurements.

In an example embodiment, the first layer 12 is a metal with strong localized surface plasmon resonance; whereas, the second layer 12 is a polymer. Suitable metals include but not limited to gold, platinum, silver, and tungsten. Non-metals are also contemplated for the first layer. On the other hand, the polymer forming the second layer may be polymers containing DBCOD. In other embodiments, the second layer of the temperature sensing member 10 may be polyisopropylacrylamide (i.e., p-NIPAM) with a much smaller elastic modulus (e.g., 100 Kpa). In such embodiments, the sensing mechanism may be based on refractive index change instead of mechanical deformation. Other types of materials also fall within the scope of this disclosure.

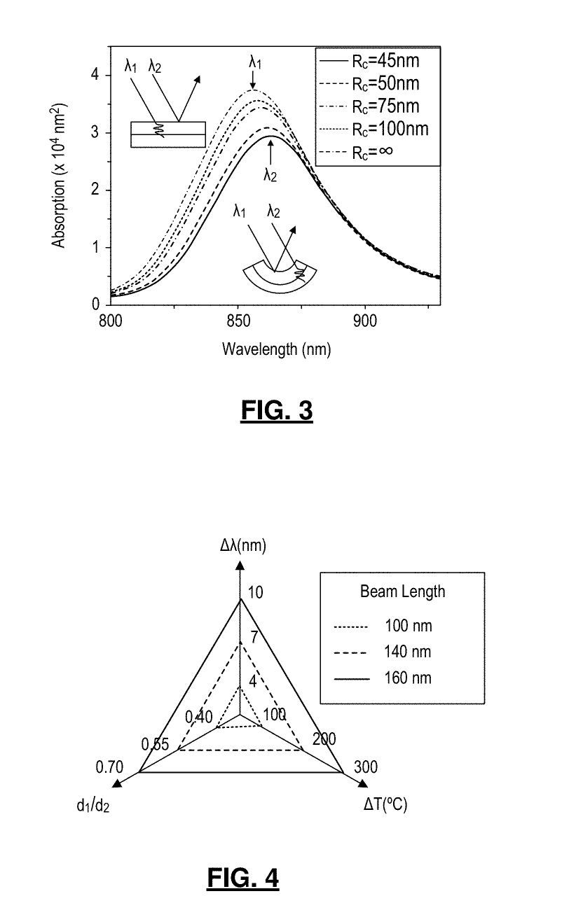

For conceptual verification of the mechano-optical temperature sensing principle, a clear and quantifiable definition of the temperature sensing member 10 is critical. The definition for the temperature sensing member 10 is illustrated in FIG. 2A. The temperature sensing member 10 is composed of two layers of materials with different coefficients of thermal expansion (α₁ and α₂ as shown in FIG. 1A). The beam length l is the longitudinal length of the temperature sensing member. The thickness ratio is defined to be the ratio of thicknesses between the first layer 12 and second layer 13 (d₁/d₂). The radius of curvature (R_{c}) is conceptually defined to be the radius of a circular arc that best approximates the curved surface. To numerically calculate R_{c}, the Timoshenko formula was used. In the absence of temperature elevation, the temperature sensing member 10 maintains a linear structure, showing an R_{c}, of infinity. Under elevated temperature, R_{c}, becomes finite. Using this quantifiable definition of the sensing geometry, a series of configurations were simulated to obtain their absorption spectra under temperature elevation. While reference is made to throughout this disclosure to a temperature sensing member in the shape of a beam, it is readily understood that other geometric shapes also fall within the scope of this disclosure.

In order to confirm that mechanical displacement is related to optical change, materials with different coefficients of thermal expansion were used in the simulation to generate different amount of mechanical deformation. It was reasoned that a larger difference between coefficients of thermal expansion (i.e., a coefficient of thermal expansion ratio (α₁/α₂) deviates from 1.00) would lead to a larger wavelength shift (Δλ). Five different material configurations for the temperature sensing member 10 were simulated whose parameters, including coefficient of α₁/α₂, R_{c}, and Δλ, are shown in Table 1 below.

TABLE 1

| Material | a₁/a₂ | R_{c} (nm) | Δλ (nm) |
|---|---|---|---|
| Au/Ni | 1.04 | −7.58 × 10⁴ | ~0 |
| Au/Pt | 1.56 | −8.73 × 10³ | 0.1 |
| Au/Si | 5.38 | −3.84 × 10³ | 0.3 |
| Au/Sn | 0.60 | 4.04 × 10³ | 0.5 |
| Au/polymer | ~0.01 | 0.79 × 10² | 10 |

The five different configurations were distinguished by their α₁/α₂ value and compared by their R_{c} and Δλ values. The relative Δλ was used instead of absolute λ in order to uniformly compare different material compositions. This table shows that a larger mechanical displacement of the temperature sensing member leads to a larger Δλ in the optical spectra. For the material combination of Au/polymer, the polymer has a large negative thermal expansion coefficient (i.e., −1000×10⁻⁶ K⁻¹). This value was taken to be close to that of the state-of-the-art materials demonstrated. All of the configurations show a clear relationship between mechanical displacement and wavelength shift. As a control, Au/Ni was simulated to verify that minute difference in the coefficients of thermal expansion between Au and Ni rendered minimal mechanical deformation and thus no optical change was observed. To closely examine the mechano-optical sensing and actuation, the absorption spectra for the Au/polymer configuration at several radius of curvature, ranging from 45 nm to infinity, was simulated and shown in FIG. 3. Upon temperature elevation and increased mechanical displacement, a significant redshift (shown in inset as λ₁ and λ₂) of the optical spectrum was observed. The redshift upon structural change is likely due to the deformation of the structure, effectively changing the localized surface plasmon resonance frequency and the coupling between two ends of the sensing member 10 upon bending. Therefore, this redshift gets more significant as the temperature increases once the coupling has been established. Additionally, a decrease in absorption intensity was also observed in FIG. 3. It is likely that this is associated with a decrease in absorption cross-section due to the attenuation of the electric dipole moment when the two ends of the sensing member 10 approach each other.

With the above study verifying our mechano-optical temperature sensing concept, the structural design parameters were further investigated by simulation to achieve optimal device performance. Structural design of the temperature sensing member refers to the shape, dimension, and geometrical structure of the device. As shown in FIG. 2, the bilayer design offers a significant mechanical displacement while remaining compatible with current micro- and nano-fabrication. Based on these considerations, the bilayer geometry was selected for further study although multilayer designs (i.e., >2) are also contemplated by this disclosure. Additionally, quantifying the mechanical displacement by R_{c} ensures a unified measurement standard. With this quantifiable definition, temperature sensing member configurations with different lengths, widths, and material compositions can be compared.

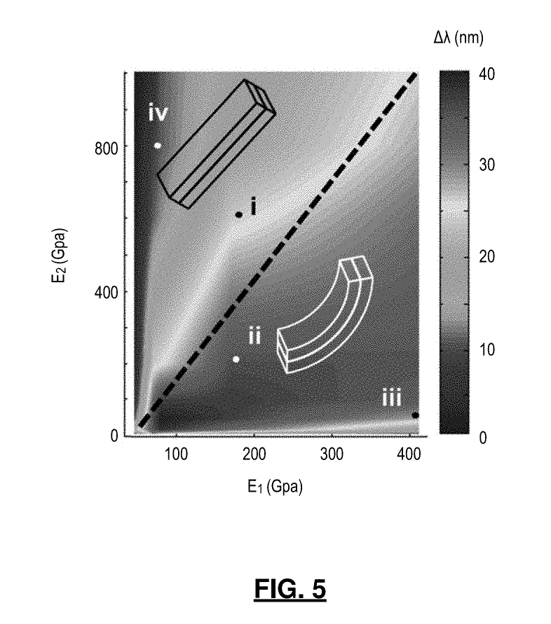

In one example embodiment, the structural design of the sensing member 10 focused on two important geometrical parameters; namely, the beam length l and thickness ratio d₁d₂, and simulated the effects of these parameters using a Gold/Polymer configuration. In FIG. 4, a larger l and a larger d₁/d₂ (up to approximately 0.7) resulted in a more significant Δλ. A similar increase in Δλ can also be observed as temperature increases (i.e., higher temperature corresponds to larger wavelength shift of the optical spectrum of the sensing member). Since l, d₁/d₂, and the aspect ratio of the first layer plays the most important roles in determination of the initial optical spectrum peak position, the target wavelength range should be determined based on the particular application. For best performance, the d₁/d₂ value depends on the coefficients of thermal expansion of the materials used in the sensing member, which should be taken into consideration during device design and fabrication. For example, a d₁/d₂ of 0.7 results in the best device performance of the Au/polymer material configuration. Any d₁/d₂ deviating this value results in a decrease in R_{c} and ultimately smaller Δλ. It is worth noting that this d₁/d₂ value that allows for maximum Δλ, based on simulation is consistent with theoretical calculation based on the Timoshenko formula.

The simulation regarding the sensing member geometry gives several fundamental design guidelines, which leads to the next important question of the influence of material properties on the mechano-optical sensing and actuation and whether general design guidelines in terms of materials can be established. Based on the result in Table 1, the closer the ratio α₁α₂ is to 1.00 (for example, in the case of Au/Ni, α₁α₂=1.04), the smaller the Δλ. Therefore, the Au/polymer configuration gives the largest mechanical displacement as well as the optical spectral change. The absolute difference between α₁ and α₂ plays a key role in the mechanical displacement of the temperature sensing member 10. In FIG. 2, assuming α₁ is a positive value, to achieve a significant Δλ, α₂ should be either a very large positive (e.g., ≧500×10⁻⁶ K⁻¹) or a very large negative number (e.g., ≦500×10⁻⁶ K⁻¹). In the case of Au/Sn, the first layer has a coefficient of 14.2×10⁻⁶ K⁻¹ and the second layer has the largest positive coefficient of thermal expansion of 23×10⁻⁶ K⁻¹ among all simulated materials; however, the resulting Δλ is not significant, which means materials with a larger coefficient of thermal expansion are required to replace the tin layer. Such materials with large positive coefficient of thermal expansion might be difficult to obtain. On the other hand, large negative coefficients of thermal expansion (≦−500×10⁻⁶ K⁻¹) have been demonstrated for polymer materials, and thus should be considered for material selection.

In addition to the coefficient of thermal expansion, Young's modulus of a material also plays a key role in device performance. To theoretically study the effect of Young's modulus, 40 different material configurations were simulated, among which the Young's moduli and coefficients of thermal expansion of four representative configurations are listed in Table 2 below.

TABLE 2

| | |
|---|---|
| Material 1 | Material 2 |

| | a₁ (10⁻⁶ K⁻¹) | E₁ (Gpa) | a₂ (10⁻⁶ K⁻¹) | E₂ (Gpa) |
|---|---|---|---|---|
| i | 13 | 170 | 998 | 600 |
| ii | 13 | 170 | 998 | 200 |
| iii | 4.3 | 411 | 979.3 | 50 |
| iv | 22.2 | 69 | 997.2 | 800 |

The purpose of these four configurations was to compare and illustrate representative performance of the sensing membrane 10 with and without a Young's moduli mismatch. Material 1 (α₁ and E₁) is composed of various metallic materials, including magnesium (Mg), aluminum (Al), gold (Au), nickel (Ni), and tungsten (W). Material 2 (α₂ and E₂) represents the polymeric material with the coefficient of thermal expansion (α) close to 1000×10⁻⁶ K⁻¹. Since Δλ is also affected by the difference in a₁ and a₂, the Δλ was calibrated by minutely (<5%) varying the coefficient of thermal expansion of the polymer so that the difference between and a₁ and a₂ remains constant for all metals. To visualize the effect of this mismatch, an interpolation map of Young's moduli (x-axis as E₁ and y-axis as E₂) and a wavelength shift (color bar as Δλ) is presented in FIG. 5. It was observed from the interpolation map that the sensing membrane 10 achieved a larger Δλ if there was no significant Young's moduli mismatch between the two materials. On the map, there also exists a high Δλ region (red) where the Δλ is significantly higher than other regions (blue). The Δλ is less significant when the ratio between the Young's module of the two materials becomes too large (e.g., >5). Interestingly, this high Δλ region (red) is asymmetric with respect to the two axes, as the region tends to be closer to E₁ and E₂. After further investigation, it was determined that the difference in layer thickness (0.7 in this case) caused this asymmetry of the high Δλ region (red). As a result, the Δλ region (red) always tends to shift toward the thinner material layer. Now the sensing member design is presented with an interesting consequence: after deciding on the materials based on the difference between a₁ and a₂, an ideal value of d₁/d₂ can be calculated. This d₁/d₂ value then in turn affects the ultimate Δλ of the device by shifting the high Δλ region (red). This demonstrates that the thickness ratio serves as a linker between the mechanical and optical properties of the sensing member. It is also worth noting that the effect of Young's modulus on the wavelength shift can be more significant than the coefficient of thermal expansion. This indicates that the material selection should entail listing out all possible candidates based on requirements of the application, calculating the position of the Δλ region, filtering materials based on their Young's moduli, and finally narrowing down candidates according to their coefficients of thermal expansion.

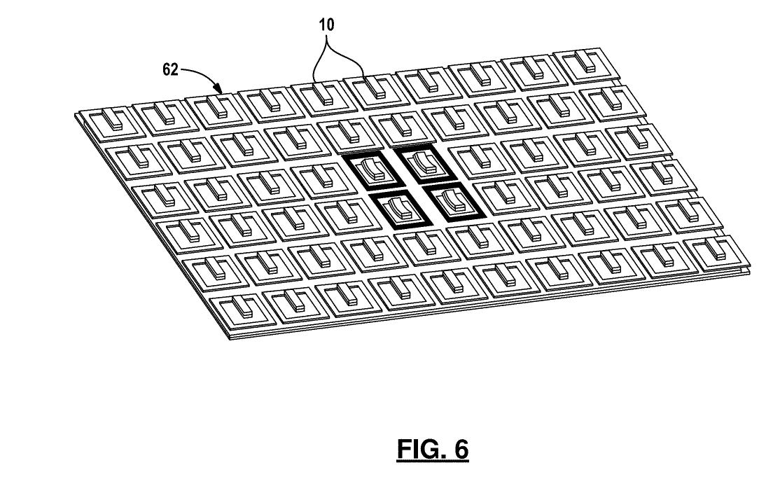

Given the nanoscale dimensions of each temperature sensing member 10, the temperature sensing members can be configured to measure temperature across small target areas, such as across biological cells or integrated circuits. In an example embodiment, temperature sensing members 10 are arranged in an array and disposed onto a sensing skin or membrane 62 as seen in FIG. 6. The sensing membrane 62 is preferably comprised of a transparent material and may be place over or attached to the target area. In one example, each temperature sensing member 10 is attached to the sensing membrane 62 by a center support anchor using a combination of electron beam lithography, spin coating and/or nano-imprint. The sensing membrane 62 enables spatiotemporal mapping of local temperature useful in various fields ranging from biomedical to electronic heat managing applications. Other techniques for constructing the sensing membrane are also envisioned by this disclosure.

FIG. 7 depicts a non-contact system 70 for measuring temperature using the temperature sensing members 10. The system includes a light source 72, a light detector 73 and a controller 74. The light source 72 operates to project light onto one or more temperature sensing members 10. In a simplified embodiment, a single sensing member 10 is used to measure temperature. In other embodiments, the light source 72 may project light onto a plurality of temperature sensing members, for example arranged on a sensing membrane as seen in FIG. 6. The light detector 73 is configured to receive light reflect by the one or more temperature sensing members 10. The term reflected is used in a general sense and may include capturing light that is forward scattered or backward scattered by the sensing members. In some embodiments, shifts in wavelengths are detected based on light backward scattered from the sensing members. In an example embodiment, the light detector 73 is spectrometer outfitted with a charge-coupled device (CCD). In the case of multiple temperature sensing members, the light detector 73 may be an imager having an array of pixels, such that different pixels (or groups of pixels) capture light reflected by different sensing members. For example, the light detector 73 may be further defined as a hyperspectral imaging device. In this way, deformation of multiple sensing members can be detected concurrently. Other types of light detectors also fall within the scope of this disclosure.

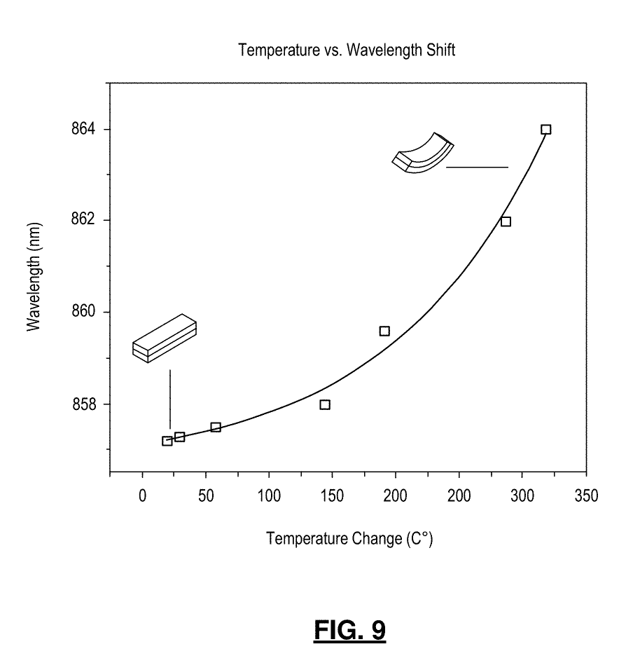

The controller 74 is interfaced with the light detector 73 and operates to determine a temperature based on a change in optical properties of light reflect by the temperature sensing member 10. For example, the controller 74 determines whether the wavelength of the detected light has shifted and, if so, quantifies the amount of shift in the wavelength of the detected light. The controller 74 in turn correlates the amount of shift in the wavelength to a change in temperature. An example of the correlation between the shift in wavelength and change in temperature change is shown in FIG. 9. Knowing an ambient or baseline temperature, the controller 74 can then determine a current temperature value using the change in temperature as indicated by the shift in the wavelength of the detected light.

In an exemplary embodiment, the controller 74 is implemented by a microcontroller. It should be understood that the logic for the control of the controller 74 can be implemented in hardware logic, software logic, or a combination of hardware and software logic. In this regard, controller 74 can be or can include any of a digital signal processor (DSP), microprocessor, microcontroller, or other programmable device which are programmed with software implementing the above described methods. It should be understood that alternatively the controller is or includes other logic devices, such as a Field Programmable Gate Array (FPGA), a complex programmable logic device (CPLD), or application specific integrated circuit (ASIC). When it is stated that the controller performs a function or is configured to perform a function, it should be understood that controller 74 is configured to do so with appropriate logic (such as in software, logic devices, or a combination thereof).

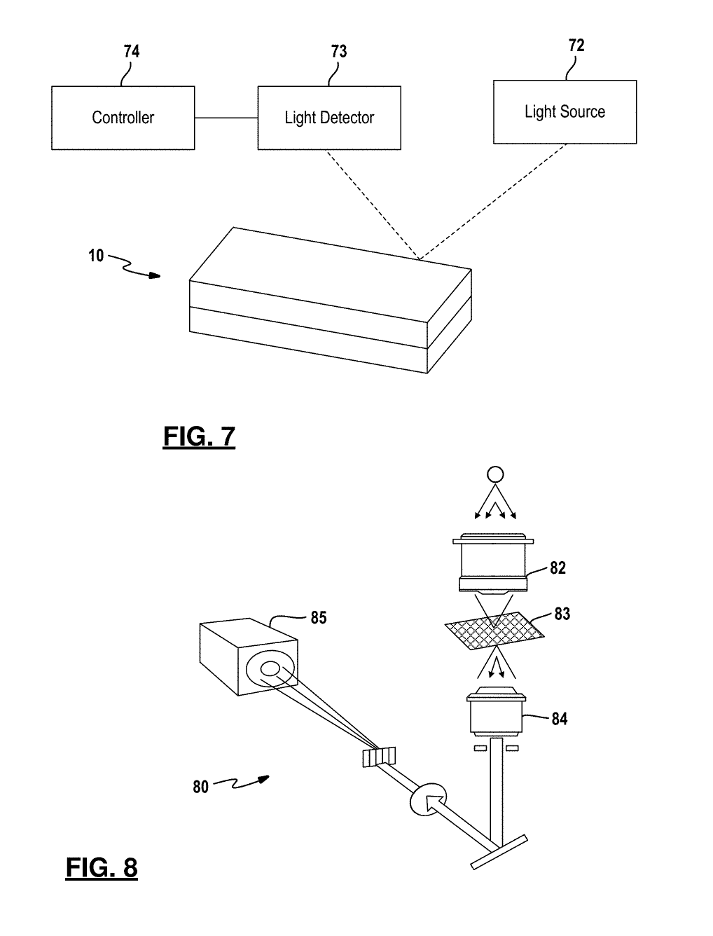

One particular example of a non-contact system 80 for measuring temperature is further described in relation to FIG. 8. The non-contact system 80 is based on dark-field sensing and includes a light source 81, a condenser 82, a sensing membrane 83 with a plurality of temperature sensing members, an objective lens 84 and a hyperspectral imager 85. In operation, temperature sensing members 10 gather the temperature information by converting thermally induced mechanical deformation and material property changes into optical signals. The sensing members feature a bilayer structure composed of a polymeric material (such as p-NIPAM and DBCOD-containing polymers) and a metallic material that are carefully selected to maximize the thermal and optical response. As the environmental temperature changes, so does the localized surface plasmon resonance (LSPR) of the metallic layer. The strong scattering signal from the individual sensors due to LSPR is captured by a darkfield sensing system and analyzed by CCD-based spectrometry. Upon temperature increases, a shift of the peak position of the scattering signal can be observed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A temperature sensor, comprising:
a temperature sensing member having a planar shape, the temperature sensing member comprised of a layer of a first material disposed on a layer of a second material, where first material differs from the second material and the first material has an elastic modulus similar to the second material but a coefficient of thermal expansion different than the second material.

2. The temperature sensor of claim 1 wherein the temperature sensing member is in shape of a rectangular cuboid.

3. The temperature sensor of claim 2 wherein the rectangular cuboid has a length less than one hundred nanometers.

4. The temperature sensor of claim 1 wherein dimensions of the temperature sensing member are on the order of nanometers.

5. The temperature sensor of claim 1 wherein the first material is a metal with strong localized surface plasmon resonance and the second material is a polymer.

6. The temperature sensor of claim 1 wherein a difference between the elastic modulus of the first material and the elastic modulus of the second material is less than two hundred percent.

7. The temperature sensor of claim 1 wherein a difference between the coefficient of thermal expansion of the first material and the coefficient of thermal expansion of the second material is greater than five thousand percent.

8. The temperature sensor of claim 1 further comprises
a light source operable to project light onto the temperature sensing member;
a light detector configured to receive light reflect by the temperature sensing member; and
a controller interfaced with the light detector and operable to determine a temperature based on a change in optical properties of light reflect by the temperature sensing member.

9. The temperature sensor further comprises a plurality of temperature sensing members arranged on a sensing membrane, where each of the temperature sensing members on the sensing membrane are constructed according to claim 1.

10. A non-contact system for measuring temperature of an object, comprising:
a sensing membrane disposed on a surface of the object;
one or more temperature sensing members attached to the sensing membrane, wherein each temperature sensing member is comprised of a layer of a first material disposed on a layer of a second material, where first material differs from the second material and the first material has an elastic modulus similar to the second material but a coefficient of thermal expansion different than the second material;
a light source operable to project light onto the temperature sensing member;
a light detector configured to receive light reflect by the temperature sensing member; and
a controller interfaced with the light detector and operable to determine a temperature based on a change in optical properties of light reflect by the temperature sensing member.

11. The non-contact system of claim 10 wherein the temperature sensing member is in shape of a rectangular cuboid.

12. The non-contact system of claim 11 wherein the rectangular cuboid has a length less than one hundred nanometers.

13. The non-contact system of claim 10 wherein dimensions of the temperature sensing member are on the order of nanometers.

14. The non-contact system of claim 10 wherein the first material is metal with strong localized surface plasmon resonance and the second material is a polymer.

15. The non-contact system of claim 10 wherein a difference between the elastic modulus of the first material and the elastic modulus of the second material is less than two hundred percent.

16. The non-contact system of claim 10 wherein a difference between the coefficient of thermal expansion of the first material and the coefficient of thermal expansion of the second material is greater than five thousand percent.

17. The non-contact system of claim 10 wherein an array of temperature sensing members are attached to the sensing membrane, and the controller is operable to determine a temperature change associated with each of the temperature sensing members in the array of temperature sensing members concurrently.
